(19) United States
(12) Patent Application Publication
(10) Pub. No.: US 2026/0148551 A1
(43) Pub. Date: May 28, 2026

(54) METHOD FOR EDITING IMAGE, IMAGE PROCESSING APPARATUS, AND COMPUTER-READABLE RECORDING MEDIUM

(71) Applicant: AmTRAN TECHNOLOGY Co., Ltd., New Taipei City (TW)

(72) Inventor: Kuo Chih Lo, New Taipei City (TW)

(73) Assignee: AmTRAN TECHNOLOGY Co., Ltd., New Taipei City (TW)

(21) Appl. No.: 19/091,852

(22) Filed: Mar. 27, 2025

(30) Foreign Application Priority Data
Nov. 27, 2024 (TW) 113145668

(51) Int. Cl. G06V 20/30; G06V 10/77; G06V 20/40; G06V 40/16; H04N 23/611; H04N 23/69; H04N 23/695

(52) U.S. Cl. CPC G06V 20/30; G06V 10/7715; G06V 20/41; G06V 20/46; G06V 40/171; H04N 23/611; H04N 23/695; H04N 23/69

(57) ABSTRACT

A method for editing an image, an image processing apparatus, and a computer-readable recording medium are provided. The image processing method includes at least the following steps: determining a scene corresponding to an image sequence and processing the image sequence according to the scene to create a multimedia file.

### CROSS-REFERENCE TO RELATED APPLICATION

This application claims the priority benefit of Taiwan application serial no. 113145668, filed on Nov. 27, 2024. The entirety of the above-mentioned patent application is hereby incorporated by reference herein and made a part of this specification.

### BACKGROUND OF THE INVENTION

### Field of the Invention

The disclosure relates to an image processing mechanism, and in particular, to a method for editing an image, an image processing apparatus, and a computer-readable recording medium.

### Description of Related Art

With the development of science and technology, electronic products equipped with cameras are becoming more and more popular. Therefore, it has become very convenient for people nowadays to take videos, photos, etc. It is also quite easy to share the captured videos on major social networking sites, social media, etc. Before sharing and uploading their works, users need to spend a lot of time using tools such as photo editing software, image and sound editing software to organize and edit the videos. The tools generally require time to learn by oneself.

However, for ordinary people, time is money, and it is not practical to spend a lot of time and energy editing images. For example, users want to shoot a short video of a home cooking to share; or, shoot a short video of assembling a computer or an electronic product to guide simple and basic needs such as the workflow of related processing work. Unless the work may bring considerable profits, most people usually do not spend a lot of time re-editing videos.

Currently, most of the products such as general cameras, video cameras, or mobile phones equipped with cameras on the market emphasize shooting original videos or photos, and do not consider the post-production issues of videos and photos. Of course, the post-production issues of videos and photos are what determine the practicality of the work. Most of the post-production issues of videos and photos require professionals or professional software, and take a lot of time to resolve. This time cost reflects the fact that it is not practical to produce and share short videos and standard operating procedures (SOP) files.

### SUMMARY OF THE INVENTION

The disclosure provides a method for editing an image, an image processing apparatus, and a computer-readable recording medium that may automatically condense an original image sequence to create an edited multimedia file.

A method for editing an image provided by the disclosure includes: determining a corresponding scene for an image sequence and processing the image sequence according to the scene to create a multimedia file.

In an embodiment of the disclosure, the step of determining the corresponding scene for the image sequence includes: performing an image recognition procedure on the image sequence to detect a plurality of objects therein; and determining the corresponding scene for the image sequence according to the objects. After determining the corresponding scene for the image sequence, further including: identifying a plurality of non-main frames in a plurality of frames in the image sequence, and removing the non-main frames from the frames to obtain a plurality of designated frames according to the scene. Then, the multimedia file is created according to the designated frames.

In an embodiment of the disclosure, the step of determining the corresponding scene for the image sequence according to the plurality of objects includes: classifying each object as a subject object corresponding to the scene or a non-subject object not classified as the subject object; counting a first number corresponding to the subject object and a second number corresponding to the non-subject object of each frame for each frame in the image sequence; and determining whether each frame is the non-main frame according to the first number and the second number.

In an embodiment of the disclosure, the step of determining the corresponding scene for the image sequence according to the plurality of objects includes: performing an artificial intelligence (AI) processing on each frame in the image sequence to identify an action associated with each frame; and determining whether each frame is the non-main frame according to whether the action is relevant to the scene.

In an embodiment of the disclosure, the step of creating the multimedia file according to the plurality of designated frames includes: dividing the plurality of designated frames into a plurality of sections according to template content corresponding to the scene; and inserting at least one corresponding text label to each section.

In an embodiment of the disclosure, the method for editing the image further includes: activating an imaging device to acquire the image sequence; performing a person tracking procedure on the image sequence to identify and track a specified person therein; and adjusting an imaging parameter of the imaging device according to a specified person's position.

In an embodiment of the disclosure, the imaging parameter includes a specified angle, and the step of adjusting the imaging parameter of the imaging device according to the specified person's position includes: transmitting an angle adjustment command to a motor module according to the specified person's position to drive the motor module to rotate the imaging device by the specified angle.

In an embodiment of the disclosure, the imaging parameter includes a specified focal length, and the step of adjusting the imaging parameter of the imaging device according to the specified person's position includes: transmitting a focal length adjustment command to the imaging device according to the specified person's position to adjust the imaging device to the specified focal length.

In an embodiment of the disclosure, the method for editing the image further includes: acquiring the specified person's person image via the imaging device upon initial activation of the imaging device; and performing a facial recognition procedure on the person image to extract a feature set from the person image, and storing the feature set for the subsequent person tracking procedure.

In an embodiment of the disclosure, the method for editing the image further includes: activating an imaging device to acquire the image sequence; receiving an audio signal from a voice input device while the imaging device acquires the image sequence; performing a voice recognition procedure on the audio signal to obtain an apparatus adjustment command; and adjusting an imaging parameter of the imaging device according to the apparatus adjustment command.

In an embodiment of the disclosure, the method for editing the image further includes: transmitting the image sequence to a display for presentation activating the imaging device to acquire the image sequence.

An image processing apparatus provided by the disclosure includes: a storage device including at least one program code segment; an imaging device; and a processor coupled to the storage device and the imaging device, wherein the processor reads the at least one program code segment to: determine a corresponding scene for an image sequence, wherein the image sequence is acquired by the processor controlling the imaging device, and processing the image sequence according to the scene to create a multimedia file.

A non-transitory computer-readable recording medium, storing at least one program segment, wherein the program segment is read by a processor in an electronic device to perform following steps: determining a corresponding scene for an image sequence, and processing the image sequence according to the scene to create a multimedia file.

Based on the above, the disclosure may automatically remove unimportant frames in the image sequence and create the multimedia file corresponding to the current scene according to the condensed plurality of designated frames. Accordingly, users do not need to learn video editing tools by themselves, nor do they need to spend a lot of time filtering the frames they want to keep.

### BRIEF DESCRIPTION OF THE DRAWINGS

FIG. 1 is a block diagram of an image processing apparatus according to an embodiment of the disclosure.

FIG. 2 is a flowchart of a method for editing an image according to an embodiment of the disclosure.

FIG. 3 is a block diagram of an image processing apparatus according to another embodiment of the disclosure.

FIG. 4 is a flowchart of a method for editing an image according to another embodiment of the disclosure.

### DESCRIPTION OF THE EMBODIMENTS

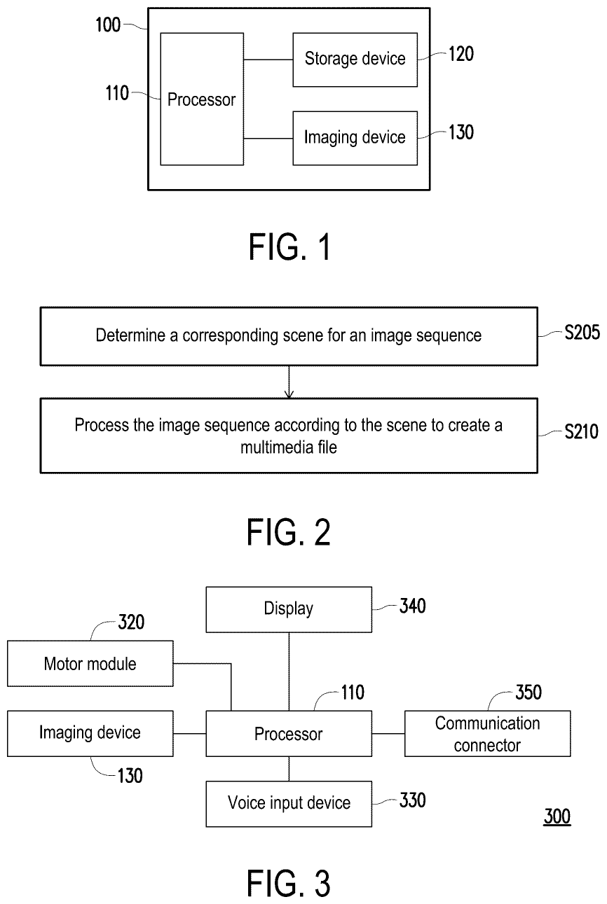

FIG. 1 is a block diagram of an image processing apparatus according to an embodiment of the disclosure. Please refer to FIG. 1, an image processing apparatus 100 includes a processor 110, a storage device 120, and an imaging device 130. The processor 110 is coupled to the storage device 120 and the imaging device 130.

The processor 110 may be implemented by a central processing unit (CPU), a physical processing unit (PPU), a programmable microprocessor, an embedded control chip, a digital signal processor (DSP), an application-specific integrated circuit (ASIC), or other similar devices.

The storage device 120 may be implemented by any type of fixed or removable random-access memory (RAM), read-only memory (ROM), flash memory, hard drive, or other similar devices or a combination of these devices. The storage device 120 includes one or more program code segments. After being installed, the one or plurality of program code segments can be executed by the processor 110 to implement a method for editing an image described below.

The imaging device 130 may be a camera adopting a charge-coupled device (CCD) lens, a complementary metal oxide semiconductor (CMOS) lens, or the like. In an embodiment, the imaging device 130 may include, for example, one camera. The specifications of this camera are 12 MP (4032×3040) resolution, 120-degree field of view providing a wider field of view, and equipped with a 5× optical zoom lens. During the image capture by the imaging device 130, more objects may be captured by zooming in or out, but the disclosure is not limited thereto.

In an embodiment, the processor 110 and the storage device 120 may also be integrated into a system-on-chip (SoC) having a neural network processor.

FIG. 2 is a flowchart of a method for editing an image according to an embodiment of the disclosure. Please refer to FIG. 1 and FIG. 2 at the same time. In step S205, a corresponding scene for the image sequence is determined. The image sequence is acquired by an electronic device (such as the image processing apparatus 100). Next, in step S210, the image sequence is processed according to the scene to create a multimedia file.

In a practical application, the image processing apparatus 100 may be a smart TV, a smart camera, a smart phone, or other image-capturing devices. The following embodiments take a smart TV as an example for description. The smart TV may acquire the image sequence via the imaging device 130, and the processor 110 performs a series of processing steps on the image sequence to identify the corresponding scene for the image sequence, so as to perform post-processing on the image sequence for this scene to create the multimedia file. Accordingly, after the image sequence is acquired, the image sequence may be condensed in time to create the multimedia file corresponding to the current scene. In the case of a smart TV, the created multimedia file may also be directly displayed on the TV screen. In the case of the smart camera, the multimedia file may also be presented via the display screen built in the smart camera.

Specifically, the processor 110 may first perform an image recognition procedure on the image sequence to detect a plurality of objects therein. In an embodiment, the image recognition procedure utilizes an image segmentation neural network module and an object detection module. For each frame in the image sequence, each frame is divided into a plurality of blocks using the image segmentation neural network module, and then each object in each block is identified and extracted using the object detection module. The image segmentation neural network module is, for example, MobileNetV3-SSD trained on the COCO data set. The object detection module is, for example, YoloV8.

Then, the processor 110 determines the corresponding scene for the image sequence according to the detected object(s). For example, “recipe making” usually takes place in the kitchen. The kitchen has objects such as kitchen utensils and ingredients. Therefore, the scene is determined according to the object categories. In an embodiment, the processor 110 classifies the detected plurality of objects according to preset classification rules. For example, the classification categories include: kitchen utensils, food ingredients, beauty and cosmetics, computer parts, etc. Then, the processor 110 may further determine the corresponding scene for the image sequence according to the number of objects included in each category according to the preset determination rules. For example, assuming that the number of objects classified in both the kitchen utensils and food ingredients categories exceeds a certain proportion of the total number of objects, the scene is determined to be “recipe making”. If the number of objects classified in the computer parts category, for example, exceeds a certain proportion of the total number of objects, the scene is determined to be “computer assembly”. If these objects cannot be classified, they are classified as general scenes. However, this is only an example and is not limited thereto.

After determining the scene, the processor 110, according to the scene, identifies a plurality of non-main frames in the plurality of frames in the image sequence, and removes the non-main frames from the frames to obtain a plurality of designated frames. In an embodiment, the processor 110 may determine for each frame whether the frame is relevant to the scene, and mark the frame not irrelevant to the scene as the non-main frame.

For example, the processor 110 classifies each object as a subject object corresponding to the scene or a non-subject object not classified as the subject object. For each frame in the image sequence, the processor 110 counts a first number corresponding to the subject object and a second number corresponding to the non-subject object of each frame. Specifically, in the objects included in each frame, the number of subject objects and the number of non-subject objects are counted. Furthermore, whether to determine the frame as the non-main frame is determined according to the first number and the second number. Next, the non-main frames are removed from the initial plurality of frames in the image sequence to obtain a plurality of main frames, and the plurality of main frames are marked as designated frames.

In addition, if the number of main frames obtained exceeds the preset threshold, the processor 110 may further filter out one or more duplicate frames from the plurality of main frames according to the similarity between two adjacent main frames in time, remove the duplicate frames from the plurality of main frames, and mark the final remaining main frame as the designated frame.

In another embodiment, the processor 110 may also perform an artificial intelligence (AI) processing on each frame in the image sequence to identify the action associated with each frame, and determine whether the action is relevant to the scene to classify each frame as the non-main frame. For example, in a “recipe making” scene, if the action in the frame is a person adjusting a screen, or the person's current action is a non-main event such as not handling food or cooking food, this frame may be marked as the non-main frame.

Then, the processor 110 creates the multimedia file according to the designated frames. At this stage, the multimedia file is, for example, a short video or a slideshow file.

In an embodiment, the processor 110 classifies the plurality of objects recognized from the image sequence into a plurality of subject objects corresponding to the scene and a plurality of non-subject objects not classified as the subject objects. Furthermore, the processor 110 records the temporal relationship between each subject object and each non-subject object. For example, the processor 110 performs a machine learning operation on the content of the original image sequence using a time series neural network to identify the temporal relationship between the subject object and each non-subject object in the image sequence. The processor 110 divides the designated frames into a plurality of sections according to the template content corresponding to the scene. Next, the processor 110 inserts at least one corresponding text label to each section.

For example, if the scene is “recipe making”, the corresponding template content for the scene includes text content correspondingly used in the two stages of ingredient processing and ingredient cooking. The processor 110 may determine the segmentation point between the food processing stage and the food cooking stage using the action of the designated frames determined by the AI operation. In addition, using the AI operation, the processor 110 may further convert main objects such as ingredients and seasonings into text, and insert at least one corresponding text label to each section. For example, a corresponding title is generated for the entire multimedia file, and corresponding text labels are generated for different stages. In addition, a corresponding image label may also be inserted.

For example, in the process of making a recipe, the preparation order and the cooking order of each ingredient are recorded according to time series. There is a temporal relationship between these sequences, which action requires specific objects, the interaction between each object, etc. In addition to ingredients, the relative relationships between objects such as chairs, tables, and windows, may also be further analyzed and listed. For example, in the ingredient processing stage, sequence of the food processing which kitchen utensil is used to process which ingredient first, and what kitchen utensil is used to process which ingredient subsequently is recorded. In the ingredient cooking stage, the ingredient cooking order of which kitchen utensil is used to cook which ingredient first, and what kitchen utensil is used to cook which ingredient subsequently is recorded. Accordingly, the appearance time of each object and the interaction between different objects are recorded.

FIG. 3 is a block diagram of an image processing apparatus according to another embodiment of the disclosure. Referring to FIG. 3, an image processing apparatus 300 includes the processor 110, the imaging device 130, a motor module 320, a voice input device 330, a display 340, and a communication connector 350. The processor 110 is coupled to the imaging device 130, the motor module 320, the voice input device 330, the display 340, and the communication connector 350.

In the present embodiment, the processor 110 is implemented using an SOC having a neural network processor. The imaging device 130 may capture more objects by zooming in or out during the image capture. The motor module 320 is used to drive the imaging device 130 to rotate. For example, the imaging device 130 has a rotating base, and the motor module 320 drives the rotating base to rotate. The motor module 320 may use a brushless motor, so as to not cause unnecessary noise due to the rotation of the motor module 320 during the image capture of the imaging device 130, and has a longer service life.

The voice input device 330 is, for example, a microphone array audio in module used to collect an on-site audio and generate a corresponding audio signal to serve as the audio source for image recording.

The display 340 is, for example, a light-emitting diode (LED) display, a liquid-crystal display (LCD), an organic light-emitting diode (OLED) display, etc. The processor 110 may drive the display 340 via, for example, an Embedded Display Port (eDP) V-by-One (VBO) interface. After the imaging device 130 is activated to acquire the image sequence, the image sequence is transmitted to the display 340 for presentation. The user may see the image in real time via the display 340 to decide whether to make a fine adjustment.

The communication connector 350 may be a chip or a circuit adopting local area network (LAN) technology, wireless LAN (WLAN) technique, or mobile communication technique. For example, a local network may be Ethernet. The wireless local area network may be Wi-Fi. The mobile communication technique is, for example, Global System for Mobile Communications (GSM), Third-Generation (3G) mobile communication technique, Fourth-Generation (4G) mobile communication technique, Fifth-Generation (5G) mobile communication technique, etc. Connection to the network via the communication connector 120 achieves the function of connecting to the cloud server, and at least one of the organized multimedia file and the original image sequence may be uploaded to the cloud server for storage in a timely manner. In addition, the multimedia file may also be published directly to a social networking site, or the multimedia file may be sent to a social application.

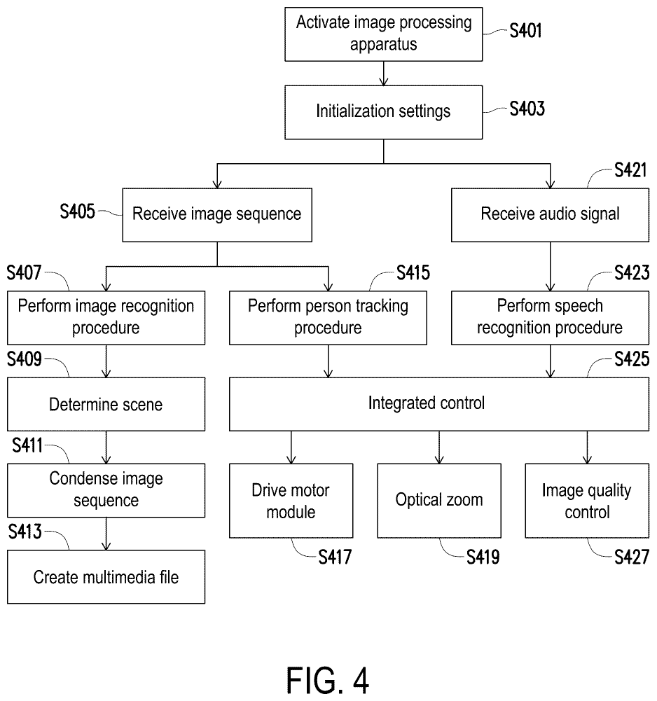

FIG. 4 is a flowchart of a method for editing an image according to another embodiment of the disclosure. Please refer to FIG. 3 and FIG. 4 together. In step S401, the image processing apparatus 300 is activated. Next, in step S403, initialization settings are performed. At this stage, when the image processing apparatus 300 is activated for the first time, the image processing apparatus 300 first asks the user to perform initialization settings. For example, a network parameter is set, and the network parameter includes (but is not limited to) a service set identifier (SSID), an account used to connect to the wireless network, and a password.

In addition, upon initial activation of the imaging device 130, the initialization setting also includes the following actions. The processor 110 acquires the specified person's person image via the imaging device 130. The processor 110 performs a facial recognition procedure on the person image to extract a feature set from the person image. For example, facial contours are separated and the feature set corresponding to the face is extracted using the facial recognition procedure. Next, the extracted feature set corresponding to the specified person is stored for the subsequent person tracking procedure.

In step S405, the imaging device 130 is activated to acquire the image sequence. In step S407, the image recognition procedure is performed. Next, in step S409, a corresponding scene for the image sequence is determined. In step S411, the image sequence is condensed. In step S413, a multimedia file is created. At this stage, detailed descriptions of steps S407, S409, S411, and S413 may be as referenced in the above steps S205, S210, S215, and S220 accordingly.

After the imaging device 130 is activated to acquire the image sequence, in step S415, a person tracking procedure is performed on the image sequence to identify and track the specified person therein. Accordingly, the processor 110 may adjust the imaging parameter of the imaging device 130 according to the specified person's position. The shooting angle of the imaging device 130 is adjusted via the person tracking procedure so that the specified person is located at the specified position (for example, the center of the screen) of the screen as much as possible.

In an embodiment, the imaging parameter includes a specified angle at which the imaging device 130 is to be rotated. For example, in step S417, the processor 110 transmits an angle adjustment command to the motor module 320 according to the specified person's position, so as to drive the motor module 320 to rotate the imaging device 130 by the specified angle.

In an embodiment, the imaging parameter includes a specified focal length. For example, in step S419, the processor 110 transmits a focal length adjustment command to the imaging device 130 according to the specified person's position to adjust the imaging device 130 to the specified focal length.

In addition, in step S425, the processor 110 may perform integrated control according to the specified person's position to transmit an angle adjustment command to the motor module 320 and transmit a focal length adjustment command to the imaging device 130, so as to perform steps S417 and S419.

While the imaging device 130 acquires the image sequence, in step S421, the processor 110 receives an audio signal from the voice input device 330. Next, in step S423, a voice recognition procedure is performed on the audio signal to obtain an apparatus adjustment command. Accordingly, the processor 110 may adjust the imaging parameter of the imaging device 130 according to the apparatus adjustment command. In an embodiment, the imaging parameter includes at least one of contrast, saturation, and color temperature. For example, in step S427, the processor 110 transmits the apparatus adjustment command to the imaging device 130 to perform image quality control.

In a practical application, if the user is not satisfied with the current image quality on the display 340, an audio signal such as “increase contrast”, “increase saturation”, or “adjust color temperature” may be input via voice, and the apparatus adjustment command is obtained via the voice recognition procedure, and then the image quality of the display 340 is adjusted according to the apparatus adjustment command.

In addition, if the user is not satisfied with the camera position of the imaging device 130 or its focal length, the user may also input an audio signal such as “zoom out”, “zoom in”, “a little to the left”, “a little to the right”, etc., by voice input to control the motor module 320 or control the focal length and/or the viewing angle of the imaging device 130.

In an embodiment, in step S425, the processor 110 may also perform integrated control according to the result of the person tracking procedure and the result of the voice recognition procedure. Specifically, the processor 110 determines whether to transmit the angle adjustment command to the motor module 320, determines whether to transmit the focal length adjustment command to the imaging device 130, and determines whether to transmit the apparatus adjustment command to the imaging device 130 according to the result of the person tracking procedure and the result of the voice recognition procedure. Furthermore, which of steps S417, S419, or S427 or a combination thereof is performed is determined.

Based on the above, the disclosure may automatically remove unimportant frames in the image sequence and create the multimedia file according to the condensed plurality of designated frames. Accordingly, users do not need to learn video editing tools by themselves, nor do they need to spend a lot of time filtering the frames they want to keep. Via the above embodiments, they may quickly and accurately generate the desired short video or slideshow file, for example.

What is claimed is:

1. A method for editing an image, suitable for an electronic device, comprising at least the following steps:
determining a corresponding scene for an image sequence, wherein the image sequence is acquired by the electronic device; and
processing the image sequence according to the scene to create a multimedia file.

2. The method for editing the image of claim 1, wherein the step of determining the corresponding scene for the image sequence comprises:
performing an image recognition procedure on the image sequence to detect a plurality of objects therein; and
determining the corresponding scene for the image sequence according to the objects;
wherein after determining the corresponding scene for the image sequence, further comprising:
identifying a plurality of non-main frames in a plurality of frames in the image sequence, and removing the non-main frames from the frames to obtain a plurality of designated frames according to the scene;
wherein creating the multimedia file comprises:
creating the multimedia file according to the designated frames.

3. The method for editing the image of claim 2, wherein the step of determining the corresponding scene for the image sequence according to the objects comprises:
classifying each object as a subject object corresponding to the scene or a non-subject object not classified as the subject object;
counting a first number corresponding to the subject object and a second number corresponding to the non-subject object of each frame for each frame in the image sequence; and
determining whether each frame is classified as one of the non-main frames according to the first number and the second number.

4. The method for editing the image of claim 2, wherein the step of determining the corresponding scene for the image sequence according to the objects comprises:
performing an artificial intelligence processing on each frame in the image sequence to identify an action associated with each frame; and
determining whether each frame is classified as one of the non-main frames according to whether the action is relevant to the scene.

5. The method for editing the image of claim 2, wherein the step of creating the multimedia file according to the designated frames comprises:
dividing the designated frames into a plurality of sections according to template content corresponding to the scene; and
inserting at least one corresponding text label to each section.

6. The method for editing the image of claim 1, further comprising:
activating an imaging device to acquire the image sequence;
performing a person tracking procedure on the image sequence to identify and track a specified person therein; and
adjusting an imaging parameter of the imaging device according to the specified person's position.

7. The method for editing the image of claim 6, wherein the imaging parameter comprises a specified angle, and the step of adjusting the imaging parameter of the imaging device according to the specified person's position comprises:
transmitting an angle adjustment command to a motor module to drive the motor module according to the specified person's position to rotate the imaging device by the specified angle.

8. The method for editing the image of claim 6, wherein the imaging parameter comprises a specified focal length, and the step of adjusting the imaging parameter of the imaging device according to the specified person's position comprises:
transmitting a focal length adjustment command to the imaging device according to the specified person's position to adjust the imaging device to the specified focal length.

9. The method for editing the image of claim 6, further comprising:
acquiring the specified person's person image via the imaging device upon initial activation of the imaging device; and
performing a facial recognition procedure on the person image to extract a feature set from the person image, and storing the feature set for the subsequent person tracking procedure.

10. The method for editing the image of claim 1, further comprising:
activating an imaging device to acquire the image sequence;
receiving an audio signal from a voice input device while the imaging device acquires the image sequence;
preforming a voice recognition procedure on the audio signal to obtain an apparatus adjustment command; and
adjusting an imaging parameter of the imaging device according to the apparatus adjustment command.

11. The method for editing the image of claim 10, further comprising:
transmitting the image sequence to a display for presentation after the imaging device is activated to acquire the image sequence.

12. An image processing apparatus, comprising:
a storage device comprising at least one program code segment;
an imaging device; and
a processor coupled to the storage device and the imaging device, wherein the processor is configured to: read the at least one program code segment to perform following steps:
determining a corresponding scene for an image sequence, wherein the image sequence is acquired by the processor controlling the imaging device; and
processing the image sequence according to the scene, thereby creating a multimedia file.

13. The image processing apparatus of claim 12, wherein the processor is configured to:
perform an image recognition procedure on the image sequence to detect a plurality of objects therein; and
determine a corresponding scene for the image sequence according to the objects;
identify a plurality of non-main frames in a plurality of frames in the image sequence, and remove the non-main frames from the frames to obtain a plurality of designated frames according to the scene; and
create the multimedia file according to the designated frames.

14. The image processing apparatus of claim 13, wherein the processor is configured to:
classify each object as a subject object corresponding to the scene or a non-subject object not classified as the subject object;
count a first number corresponding to the subject object and a second number corresponding to the non-subject object of each frame for each frame in the image sequence; and
determine whether each frame is classified as one of the non-main frames according to the first number and the second number.

15. The image processing apparatus of claim 13, wherein the processor is configured to:
perform an artificial intelligence processing on each frame in the image sequence to identify an action associated with each frame; and
determine whether each frame is classified as one of the non-main frames according to whether the action is relevant to the scene.

16. The image processing apparatus of claim 13, wherein the processor is configured to:
divide the designated frames into a plurality of sections according to template content corresponding to the scene; and
insert at least one corresponding text label to each section.

17. The image processing apparatus of claim 12, wherein the processor is configured to:
activate the imaging device to acquire the image sequence;
perform a person tracking procedure on the image sequence to identify and track a specified person therein; and
transmit an angle adjustment command to a motor module to drive the motor module to rotate the imaging device by a specified angle according to the specified person's position.

18. The image processing apparatus of claim 12, wherein the processor is configured to:
activate an imaging device to acquire the image sequence;
perform a person tracking procedure on the image sequence to identify and track a specified person therein; and
transmit a focal length adjustment command to the imaging device according to the specified person's position to adjust the imaging device to a specified focal length.

19. The image processing apparatus of claim 12, wherein the processor is configured to:
activate the imaging device to acquire the image sequence;
perform a person tracking procedure on the image sequence to identify and track a specified person therein; and
adjust an imaging parameter of the imaging device according to the specified person's position,
wherein upon initial activation of the imaging device, the processor obtains the specified person's person image via the imaging device, performs a facial recognition procedure on the person image to obtain a feature set from the person image, and stores the feature set for the subsequent person tracking procedure.

20. A non-transitory computer-readable recording medium, storing at least one program segment, wherein the program segment is read by a processor in an electronic device to perform at least the following steps:
determining a corresponding scene for an image sequence, wherein the image sequence is acquired by the electronic device; and
processing the image sequence according to the scene, thereby creating a multimedia file.
